(19) United States
(12) Patent Application Publication
(10) Pub. No.: US 2012/0060706 A1
(43) Pub. Date: Mar. 15, 2012

(54) Compacting Waste Container

(76) Inventors: Jeff Brown, Mifflintown, PA (US); Israel Weiss, Brooklyn, NY (US)

(21) Appl. No.: 12/882,319

(22) Filed: Sep. 15, 2010

(51) Int. Cl. B30B 5/02

(52) U.S. Cl. 100/211

(57) ABSTRACT

A trash compaction container and system is disclosed. The trash container includes a compaction system that manually reduces the volume of trash disposed within the trash container.

### BACKGROUND

The application generally relates to a waste or trash bin, and more specifically to a waste container that compacts waste.

In the past, trash baskets were provided as a simple container or basket. Such baskets were placed in kitchens and elsewhere for the temporary storage of kitchen, bathroom or general household trash, before being removed from the household for general home pickup or removal. The baskets may or may not have included a removable liner.

The garbage contained in these conventional containers is usually loose and bulky so that the amount of void volume in the container is high, thus requiring early removal of the waste and less efficient use of any removable liners there within.

What is needed is a trash container that is economical and environmentally friendly that compacts trash so as to efficiently use a trash removable liner.

Intended advantages of the disclosed systems and/or methods satisfy one or more of these needs or provide other advantageous features. Other features and advantages will be made apparent from the present specification. The teachings disclosed extend to those embodiments that fall within the scope of the claims, regardless of whether they accomplish one or more of the aforementioned needs.

### SUMMARY

The following embodiments and aspects thereof are described and illustrated in conjunction with systems and methods that are meant to be exemplary and illustrative, not limiting in scope. In various embodiments, one or more of the limitations described above in the Background have been reduced or eliminated, while other embodiments are directed to other improvements.

A first embodiment of the disclosure includes a trash container that includes a bin at least partially defining an interior space, the bin having a top, a bottom, and an opening defined by a rim surrounding the top, a pair of opposing horizontal slots disposed in opposing side walls of the bin, a pair of opposing vertical slots in open communication with corresponding opposing horizontal slots, a pair of compaction members extending through the interior space and configured to move across the opposing horizontal slots to the opposing vertical slots and down the opposing vertical slots to compact an amount of trash disposed within the interior space of the bin.

Another embodiment of the disclosure includes a method of trash compaction system including a trash container that includes a bin at least partially defining an interior space, the bin having a top, a bottom, and an opening defined by a rim surrounding the top, a pair of opposing horizontal slots disposed in opposing side walls of the bin, a pair of opposing vertical slots in open communication with corresponding opposing horizontal slots, a pair of compaction members extending through the interior space and configured to move across the opposing horizontal slots to the opposing vertical slots and down the opposing vertical slots. The trash compaction system further includes a removable liner. The pair of compaction members reduce the volume of the removable liner when moved down the opposing vertical slots.

Another embodiment of the disclosure includes a method of trash compaction including disposing trash into an interior space of a bin, and manually moving a pair of compaction members across a horizontal slot and a vertical slot in the bin to compact the trash.

Alternative exemplary embodiments relate to other features and combinations of features as may be generally recited in the claims.

### BRIEF DESCRIPTION OF THE FIGURES

FIG. 1 illustrates an embodiment of a trash container according to the invention.

FIG. 2A illustrates a side view of the trash container of FIG. 1.

FIG. 2B illustrates a side view on another embodiment of a trash container according to the invention.

FIG. 3 illustrates a trash container system including the trash container of FIG. 1.

FIG. 4A illustrates a partial cut away side view the trash container system of FIG. 3 during a compaction cycle.

FIG. 4B illustrates a partial cut away side view of another embodiment of a trash container system during a compaction cycle.

### DETAILED DESCRIPTION OF THE EXEMPLARY EMBODIMENTS

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present disclosure provides novel solutions for temporary trash storage and trash compaction. As used herein, the term “trash compaction” means to reduce the volume of an amount of trash.

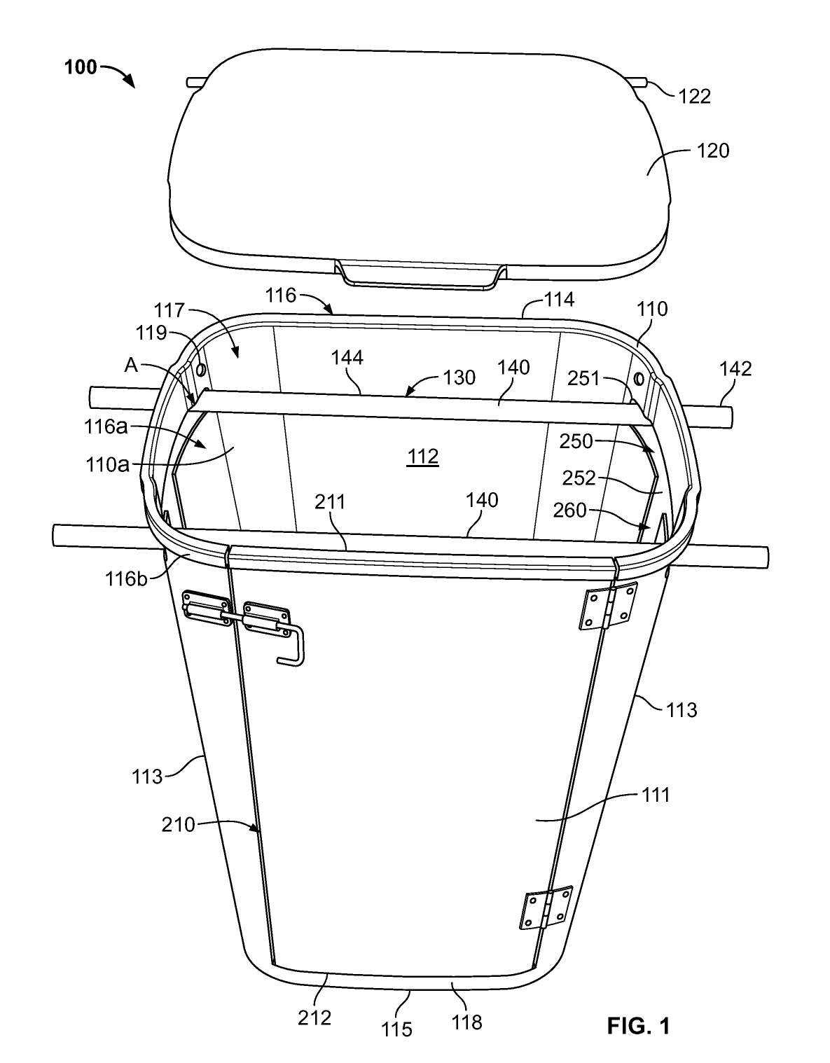

FIG. 1 illustrates an overview of the present invention, in accordance with various embodiments. As illustrated in FIG. 1, an embodiment of a trash container 100 according to the present invention. The trash container 100 includes a bin 110, a lid 120, and a trash compacting system 130. The bin 110 includes an interior surface 110a, a front side 111, a rear side 112 and opposing sides 113 there between. The bin 110 further includes a top 114 and a bottom 115. The bin further includes a top rim 116 and a lower rim 118. The top rim 116 defines a top opening 116a to the interior space 117. The bin 110 at least partially encloses and defines an interior space 117. In this exemplary embodiment, the trash container 100 has a generally rectangular cross section. In another embodiment, the trash container 100 may have a square, circular, oval or other cross section. The trash container 100 may be formed of natural materials, such as, but not limited to wood, or synthetic material, such as, but not limited to plastics, polymers, ceramics, metals and metal alloys. For example, the trash container 100 may be formed of polyvinyl chloride (PVC).

In this exemplary embodiment, the trash container 100 includes a door 210. The door is disposed in the front side 111. The door 210 includes a top edge 211, a bottom edge 212, and opposing side edges 213. The door 210 is attached to the bin 110 by a pivotal attachment device 222 attached to the door along one of the side edges 213. In this exemplary embodiment, the pivotal attachment device 222 is a pair of hinges. In another embodiment, the pivotal attachment device 222 may be, but not limited to, hinges, flexible straps, or other pivotally rotational devices. Additionally, the door 210 is secured in a closed position, as shown in FIG. 1, by a fastener 224. In this exemplary embodiment, the fastener 224 is a latch. In another embodiment, the fastener 224 may be, but is not limited to a pin and receiver, hook and loop, or other closure device. In another embodiment, the fastener 224 may be a long vertical latch extending the length of the door 210 and latch into the lower rim 118. The long vertical latch may add stability to the door 210. The hinged side of the door will have enough stability). In another embodiment, the door 210 may be secured by friction, and no fastener 224 is used. Furthermore, in this exemplary embodiment, the door 210 pivots on a vertical axis. In another embodiment, the door 210 pivots on a horizontal axis. For example, the door 210 may be attached to the bin 110 by a pivotal attachment device 222 along the bottom edge 212, such that the door 210 pivots or swings out from the bin from the top edge 211. The door 210 is positioned above the lower rim 118 in a manner that any fluid in on the bottom interior space i.e. spillage (not shown) may be retained in the bin 110. In another embodiment, the door 210 may be disposed in the rear side 112 or one of the opposing sides 113. In yet another embodiment, the trash container 100 may not include a door 210.

The lid 120 includes protrusions 122. In this exemplary embodiment, the lid 120 is removably attachable to the bin 110 by protrusions 122, which are received in openings 119 in the opposing sides 113 of bin 110. In this configuration, the lid 120 pivots about the protrusions 122 so as to swing up and away from the front side 111 to open the interior space 117 so as to receive trash or to remove the removable liner 310 from the interior space 117. In another embodiment, the lid 120 may be attached to the bin 110 by an attachment device. In one embodiment, the lid 120 may be pivotally attached to the bin 110 by a pivotal fastener, such as, but limited to a hinge. In yet another embodiment, the lid 120 may be optional to the trash container 100. In yet another embodiment, the trash container 100 does not include a lid 120.

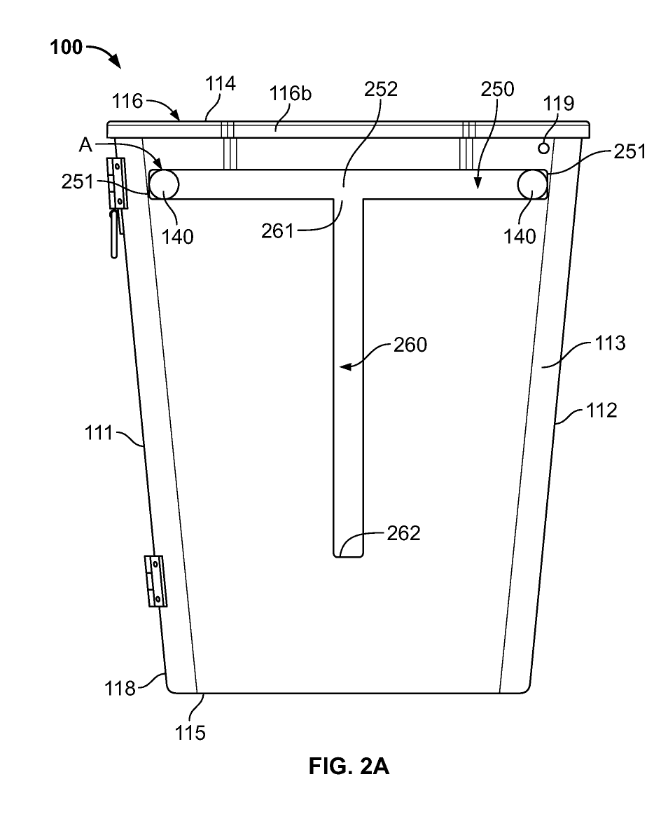

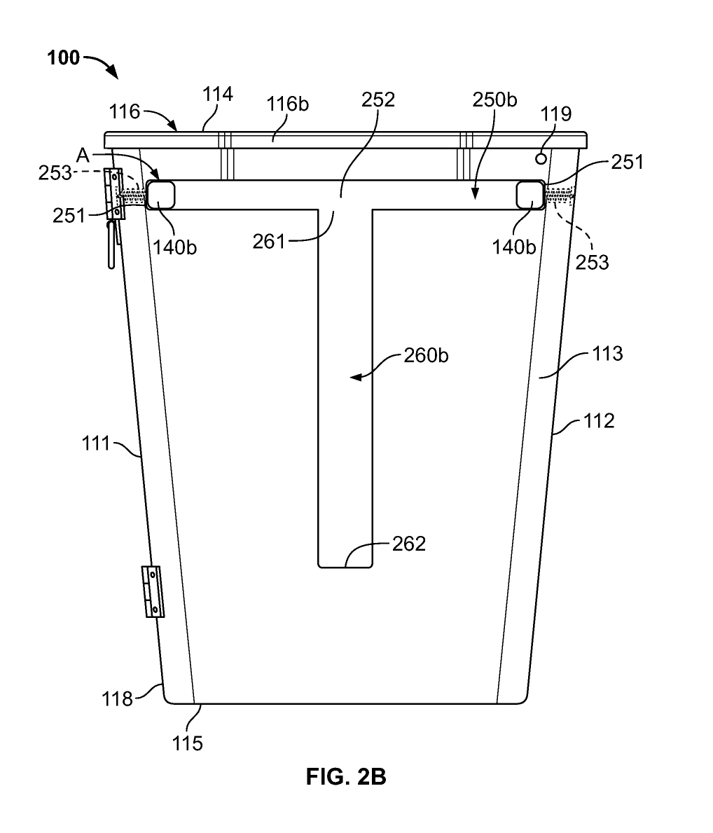

FIG. 2A shows a side view of the trash container 100. As can be seen in FIGS. 1 and 2A, each of the opposing sides 113 includes a horizontal slot 250 and a vertical slot 260. In such a manner, each horizontal slot 250 is opposite an opposing horizontal slot 250. The horizontal slot 250 includes ends 251 and a midpoint 252. The horizontal slot 250 is proximate to the top 114. As defined herein, proximate to the top 114 means less than about 10% of the vertical length of the opposing sides 113. In another embodiment, proximate the top means less than about 5% of the vertical length of the opposing sides 113. In this exemplary embodiment, each horizontal slot 250 is substantially horizontally level. In another embodiment, each horizontal slot 250 is inclined downwards towards the vertical slot 260 of that side. Each side's vertical slot 260 is in open communication with the horizontal slot 250 of that side. The vertical slot 260 includes a top end 261 and a bottom end 262. The vertical slot 260 extends from the horizontal slot 250 towards the bottom 115.

Referring to FIGS. 1 and 2A, the trash compacting system 130 includes compaction members 140. The compaction members 140 extend between and through the two opposing sides 113. Each of the compaction members 140 includes a handle portion 142 and a compaction portion 144. The handle portion 142 is disposed exterior to the bin 110, and the compaction portion 144 is disposed in the interior of the bin 110. The compaction members 140 are sized to move horizontally through the horizontal slot 250 from end 251 to midpoint 252 and through the vertical slot 260 from the top end 261 to the bottom end 262. In this exemplary embodiment, the compaction members 140 are sized to move vertically adjacent to one another through the vertical slots 260, or in other words, compaction members 140 are too wide when horizontally adjacent to fit in the vertical slot 260. In this exemplary embodiment, the compaction members 140 have a general rod shape and generally circular cross section. In another embodiment, one or both of the compaction members 140 may have, but are not limited to, a generally oval, square, rectangular, hexagonal or other geometric cross section. In another embodiment, a track system (not shown) is to support the compaction members 140 in the horizontal and/or vertical slots 150, 260. In such a manner, the compaction members 140 may slide along the track supported. The compaction members 140 may be or permanently or removably attached to the track.

In another embodiment shown in FIG. 2B, the compaction members 140 have square cross section and sized to move horizontally adjacent to one another downward through the vertical slot 260. In this manner, the compaction members 140 remain horizontal to each other while traveling vertically downward, thus increasing the compaction area and force applied to the trash and trash bag.

As shown in FIGS. 1 and 2A, the compaction members 140 are positioned proximate to the ends 251 of each opposing horizontal slot 250, otherwise known as in open position “A”. In this exemplary embodiment, the compaction members 140 are manually moved across each opposing sides 113 horizontal and vertical slot 250, 260. In another embodiment, and as shown in FIG. 2B, the compaction members 140 may be mechanically urged towards ends 251 by a return device 253. In this exemplary embodiment, the return device 251 is a spring attached at one end to bin 110 and at the opposite end to compaction members 140. In another embodiment, the return device 253 may be a band or other resilient component capable of resiliently urging the compaction devices 140 towards ends 251. In such a manner, the springs may urge the compaction members 140 towards ends 251 of horizontal slot 250 in an open position A.

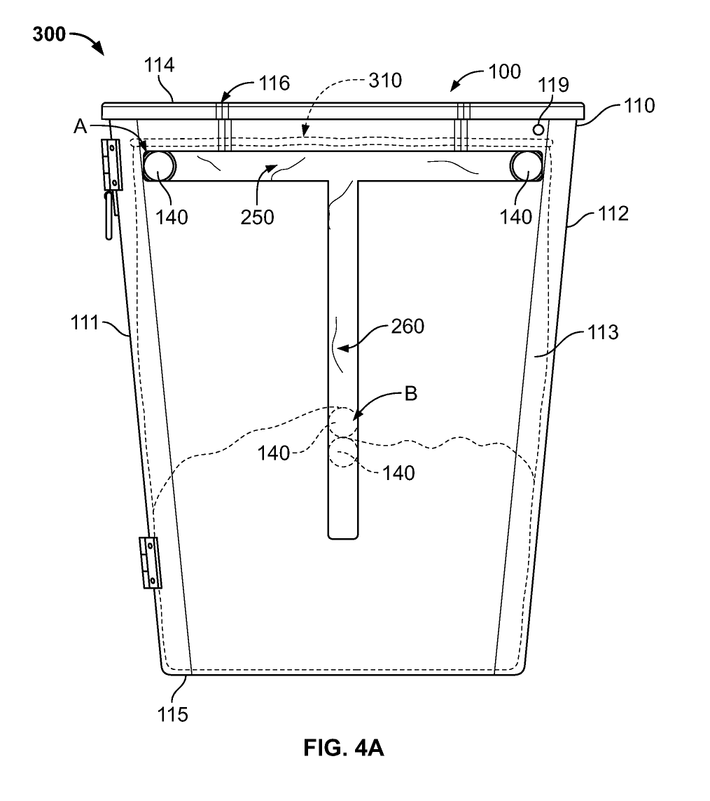

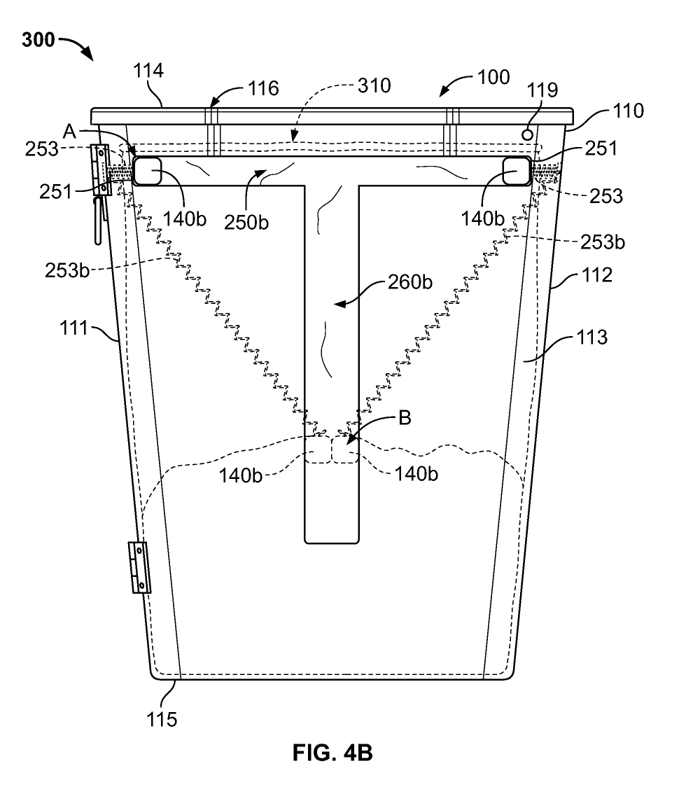

FIG. 2B illustrates another embodiment of the trash container 100 including compaction members 140b. As can be seen in FIG. 2B, the compaction members 140b have a square cross section. In this embodiment, the vertical slot 260b has been widened to receive compaction members 140b in a side-by-side arrangement (see FIG. 4B). Also in this embodiment, the compaction members 140b are attached to the front and rear sides 111, 112 by a return device 253. The return device 253 is a spring that has been attached the compaction members 140b and the front and rear sides 111, 112 so as to urge the compaction members 140 towards either ends 251, respectively.

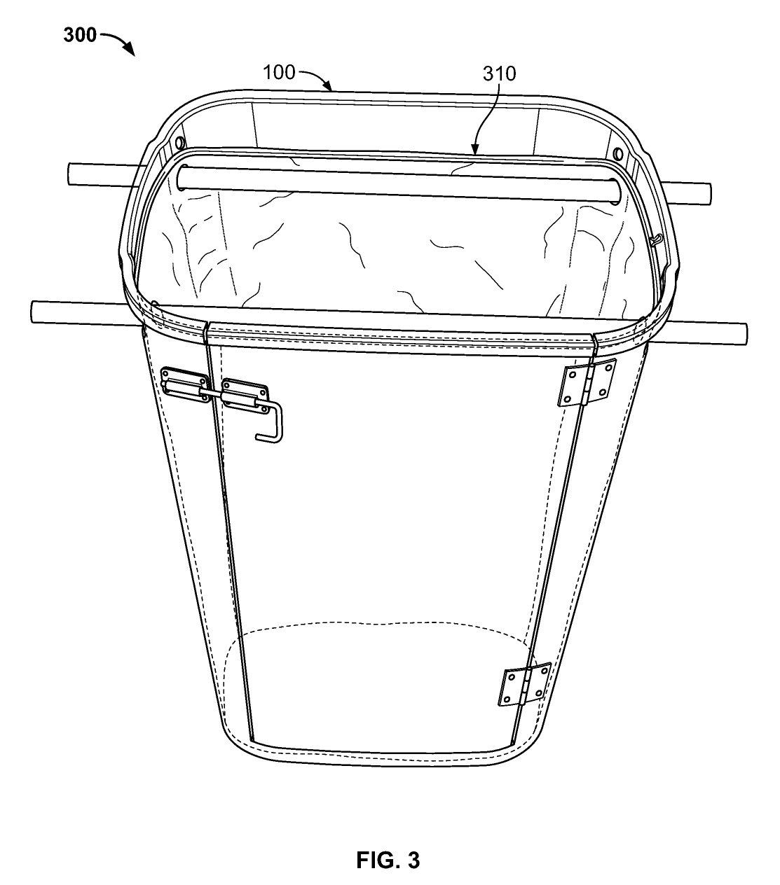

FIG. 3 shows a trash compaction system 300 according to an embodiment of the invention. As can be seen in FIG. 3, the trash compaction system 300 includes the trash container 100 and a removable liner 310 disposed within the trash container 100. The removable liner 310 includes an opening 312 and can generally be referred to as having a bag or sack configuration. As can be seen in FIG. 3, the trash compaction system 300 is in an open configuration having the trash container 100 in an open position A and the removable liner 510 configured to receive trash placed into the interior space 117 of the bin 110. The trash compaction system 300 is shown without optional lid 120.

As can be seen in FIG. 3, the removable liner 310 includes openings 312 configured to receive the compaction members 140, such that the removable liner 310 is supported within the interior space 117 of the bin 110. In another embodiment, the removable liner 310 is removably attached to the compaction members 140 by attachment devices, such as, but not limited to, hooks, loops, straps, hook and loop straps, or other similar system for temporarily affixing the removable liner 310 to the compaction members 140.

FIG. 4A shows a partial side view of the trash compaction system 300. As can be seen in FIG. 4A, the opening 312 of the removable liner 310 is closed when the compaction members 140 are moved across the horizontal slot 250 to the midpoint 252 and moved down the vertical slot 260. The compaction members 140 move down the vertical slot 260 to collapse the removable liner 310 upon itself and compress trash within the removable liner 310 while moved to a compaction position B. When the removable liner 310 is considered full, or otherwise desirable to be removed from the trash compaction system 300, the removable liner 510 is detached from the compaction members 140 by withdrawing the compaction members 140 outward from the bin 110 via the horizontal slot 250 to permit the compaction members 140 to be withdrawn from the openings 512. The removable liner 310 may then be removed from the trash container 100 via top opening 116a or via a front opening defined by opening the door 210.

In another embodiment of the trash compaction system 300 shown in FIG. 4B, the compaction members 140b are moved across the horizontal slot 250b to the vertical slot 260b and moved downward through the vertical slot 260b in a side-by-side horizontal arrangement. In such an arrangement, the compaction members apply force to a greater area of the trash compared to if the trash compaction members 140b were in a side-by-side vertical arrangement. In this exemplary embodiment, return devices 253 urge the compaction members 140b towards ends 251 from an extended arrangement 253B during a trash compaction cycle. In this exemplary embodiment, the compaction members 140b have a square cross section. In another embodiment, the compaction members 140b may have a circular, oval, rectangular, hexagonal or other geometric cross section.

In another embodiment, the removable liner 310 is not attached to the compaction members 140, but is attached to the top rim 116 by overlapping and folding over the top rim 116 so as to surround an outer surface 116b of the top rim 116. In another embodiment, the removable liner 310 is attached to the top rim 116 by a fastener, such as, but not limited to, hooks, straps, bands or other similar attachment devices. The removable liner 310 is further disposed between the compaction members 140 while in an open position A (FIG. 3) into the interior space 117 of the bin 110. In this embodiment, the trash compaction system 300 is operated by detaching the removable liner 310 from the top rim 116, positioning the removable liner 310 under the compaction members 140, and moving the compaction members 140 across the horizontal slot 250 and down the vertical slot 260 of each of the opposing sides 113 to a compaction position B (FIG. 4) so as to compact trash disposed within the removable liner 310 and brought into contact with the compaction members 140. The compaction members 140 may then be returned to ends 251 and the removable liner 310 re-attached to the top rim 116 to further receive trash or the removable liner 310 may be removed from the bin 110 for disposal.

In yet another embodiment, the removable liner 310 is not attached to the compaction members 140, but is attached to the interior surface 110a of bin 110. The removable liner 310 may be attached to the interior surface 110a by a fastener, such as, but not limited to, hooks, straps, bands or other similar attachment devices. In this embodiment, the trash compaction system 300 is operated by detaching the removable liner 310 from the interior surface 110a, positioning the removable liner 310 under the compaction members 140, and moving the compaction members across the horizontal slot 250 and down the vertical slot 260 of each of the opposing sides 113 to a compaction position B (FIG. 4) so as to compact trash disposed within the removable liner 310 and brought into contact with the compaction members 140. The compaction members 140 may then be returned to ends 251 and the removable liner 310 re-attached to the interior surface 110a to further receive trash or the removable liner 310 may be removed from the bin 110 for disposal.

While the disclosure has been described with reference to exemplary embodiment, it will be understood by those skilled in the art that various changes may be made and equivalents may be substituted for elements thereof without departing from the scope of the disclosure. The order or sequence of any process or method steps may be varied or re-sequenced according to alternative embodiments. Other substitutions, modifications, changes and omissions may be made in the design, operating conditions and arrangement of the exemplary embodiments without departing from the scope of the present application. It should be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims. It is therefore intended that the following appended claims and claims hereafter introduced are interpreted to include all such modifications, permutations, additions, and sub-combinations as are within their true spirit and scope.

What is claimed is:

1. A trash container, comprising:
a bin at least partially defining an interior space, the bin having a top, a bottom, and an opening defined by a rim surrounding the top;
a pair of opposing horizontal slots disposed in opposing side walls of the bin;
a pair of opposing vertical slots in open communication with corresponding opposing horizontal slots;
a pair of compaction members extending through the interior space and configured to move across the opposing horizontal slots to the opposing vertical slots and down the opposing vertical slots to compact an amount of trash disposed within the interior space of the bin.

2. The trash container of claim 1, wherein the pair of opposing horizontal slots are located proximate to a top to the bin and are in open communication with the corresponding opposing vertical slots, and wherein the opposing vertical slots extend from the opposing horizontal slots towards the bottom of the bin.

3. The trash container of claim 1, wherein the pair of compaction members are a pair of rods.

4. The trash container of claim 1, further comprising a return device for urging the pair of compaction members towards opposing ends of the horizontal slot.

5. The trash container of claim 1, wherein the bin has a substantially rectangular cross section.

6. The trash container of claim 1, wherein the bin comprises a door that accesses the interior space.

7. The trash container of claim 2, wherein the rods have a substantially circular cross section.

8. A trash compaction system, comprising:
a trash container comprising:
a bin at least partially defining an interior space, the bin having a top, a bottom, and an opening defined by a rim surrounding the top;
a pair of opposing horizontal slots disposed in opposing side walls of the bin;
a pair of opposing vertical slots in open communication with corresponding opposing horizontal slots;
a pair of compaction members extending through the interior space and configured to move across the opposing horizontal slots to the opposing vertical slots and down the opposing vertical slots; and
a removable liner;
wherein the pair of compaction members reduce the volume of the removable liner when moved down the opposing vertical slots.

9. The system of claim 8, wherein the pair of opposing horizontal slots are located proximate to a top to the bin and are in open communication with the corresponding opposing vertical slots, and wherein the opposing vertical slots extend from the opposing horizontal slots towards the bottom of the bin.

10. The system of claim 8, wherein the pair of compaction members are a pair of rods.

11. The system of claim 8, further comprising a return device for urging the pair of compaction members towards opposing ends of the horizontal slot.

12. The system of claim 10, wherein the rods have a substantially circular cross section.

13. The system of claim 8, wherein the bin has a substantially rectangular cross section.

14. The system of claim 8, wherein the bin comprises a door that accesses the interior space.

15. The system of claim 8, wherein removable liner is releasably attached to the pair of compaction members.

16. The system of claim 8, wherein the removable liner is releasably attached to the bin.

17. A method of trash compaction, comprising:
disposing trash into an interior space of a bin;
manually moving a pair of compaction members across a horizontal slot and a vertical slot in the bin to compact the trash.

18. The method of claim 17, further comprising:
manually returning the pair of compaction members to an open position at opposing ends of the horizontal slot.

19. The method of claim 17, further comprising:
returning the pair of compaction members to an open position at opposing ends of the horizontal slot with the assist of a return device.

20. The method of claim 17, wherein the return device is a spring.
